(19) United States
(12) Patent Application Publication
(10) Pub. No.: US 2013/0100957 A1
(43) Pub. Date: Apr. 25, 2013

(54) INFORMATION PROCESSING SYSTEM, RELAY DEVICE, AND INFORMATION PROCESSING METHOD

(71) Applicants: Hideaki Suzuki, Koganei-shi (JP); Hidefumi Sawai, Koganei-shi (JP); Hiroyuki Ohsaki, Suita-shi (JP)

(72) Inventors: Hideaki Suzuki, Koganei-shi (JP); Hidefumi Sawai, Koganei-shi (JP); Hiroyuki Ohsaki, Suita-shi (JP)

(73) Assignee: National Institute of Information and Communications Technology, Koganei-shi, Tokyo (JP)

(21) Appl. No.: 13/807,001

(22) PCT Filed: Jun. 21, 2011
(86) PCT No.: PCT/JP2011/064108

§ 371 Date: Dec. 26, 2012

(30) Foreign Application Priority Data
Jun. 23, 2010 (JP) 2010-142508

(51) Int. Cl. H04L 12/56

(52) U.S. Cl. CPC H04L 45/60
USPC 370/392

(57) ABSTRACT

An information processing system is provided which includes a plurality of networked relay nodes and a management node. Each of the relay nodes includes a transfer unit for transferring a received packet to another node in accordance with route control information, a storage unit for storing process rules, determination logic for determining whether the received packet is a process-target packet serving as a target to be processed in the relay node, processing logic for, upon receiving a process packet at the relay node, executing a process corresponding process-identifying information included in the packet on process data included in the packet in accordance with the process rules, and determination logic for determining a destination to which a result obtained by processing the process data is transferred. The process-target packet includes process-identifying information indicating a content of a process to be executed, and process-target data serving as a target of the process.

### TECHNICAL FIELD

The present invention relates to an information processing system, a relay device, and an information processing method using a dataflow architecture on a network.

### BACKGROUND ART

Computer architectures generally used at present include Neumann computers and control flow computers. Computer architectures developed with a concept different from those computer architectures include dataflow architectures.

Such dataflow architectures are characterized in that calculation is sequentially performed by being driven by data. In a historical point of view, dataflow architectures were actively studied from 1970s to the early 1980s.

The research and development of dataflow architectures as described above mainly focused on increasing the speed of program execution by parallel processing. Development and research of various dataflow computers have been conducted until now, and a number of methods of implementing dataflow architectures have been studied.

PTLs 1 to 3 disclose dedicated hardware for implementing data-driven data flows.

### CITATION LIST

### Patent Literature

PTL 1: Japanese Patent Laying-Open No. 06-259583
PTL 2: Japanese Patent Laying-Open No. 05-000312
PTL 3: Japanese Patent Laying-Open No. 04-288733

### SUMMARY OF INVENTION

### Technical Problem

However, ordinary dataflow computers are implemented with dedicatedly designed hardware and cannot reach a practically sufficient level in terms of scalability, flexibility, and extensibility that fits the scale of dataflow programs.

The present invention is made in order to solve the problems as described above. An object of the present invention is to provide an information processing system using a dataflow architecture with higher scalability, flexibility, and extensibility, and a relay device directed to the system, and an information processing system.

### Solution to Problem

An information processing system according to an aspect of the present invention includes a plurality of networked relay nodes and a management node. Each of the relay nodes includes transfer means for transferring a received packet to another relay node in accordance with route control information, storage means for storing process rules, determination means for determining whether the received packet is a process-target packet serving as a target to be processed in the relay node, and synchronization means for waiting for arrival of a plurality of process-target packets required for execution of the process rules. Here, the process-target packet includes process-identifying information indicating a content of a process to be executed, and process-target data serving as a target of the process. Each of the relay nodes further includes processing means for, when the process-target packet is received at the relay node, executing a process corresponding to the process-identifying information included in the packet on the process-target data included in the packet, in accordance with the process rules, and determination means for determining a destination to which a result obtained by processing the process-target data is transferred. The management node includes allocation means for allocating information processing of interest to the plurality of relay nodes, transmission means for transmitting the process rules to the plurality of relay nodes, based on the allocation result, reception means for receiving a result in the processing means from the plurality of relay nodes, and change means for changing the route control information of the relay node based on the result obtained by the reception means.

Preferably, each of the relay nodes further includes generation means for generating a packet including the result obtained by processing the process-target data, as the process-target data.

Preferably, the process rules include a definition for repeating a same process a prescribed number of times, and when a packet including designation for repeating a same process a prescribed number of times as the process-identifying information is received, the processing means repeats the process until the process-target packet is received by the designated number of times.

Preferably, each of the relay nodes stores the process-identifying information included in the process-target packet and route information determined by the transfer means. Each of the relay nodes includes reverse transfer means for transferring the process-target packet in a reverse direction through a path through which the process-target packet passes, and a change function of changing the process rules in the relay node, based on the process-identifying information and the process-target data included in the packet.

According to another aspect of the present invention, a relay device directed to information processing using a plurality of networked relay nodes is provided. The relay device includes transfer means for transferring a received packet to another relay device in accordance with route control information, storage means for storing process rules, and determination means for determining whether the received packet is a process-target packet serving as a target to be processed in the relay device. Here, the process-target packet includes process-identifying information indicating a content of a process to be executed, and process-target data serving as a target of the process. The relay device further includes processing means for, when the process-target packet is received at the relay device, executing a process corresponding to the process-identifying information included in the packet on the process-target data included in the packet, in accordance with the process rules, and determination means for determining a destination to which a result obtained by processing the process-target data is transferred.

Preferably, the relay device further includes generation means for generating a packet including the result obtained by processing the process-target data, as the process-target data.

Preferably, the process rules include a definition for repeating a same process a prescribed number of times, and when a packet including designation for repeating a same process a prescribed number of times as the process-identifying information is received, the processing means repeats the process until the process-target packet is received by the designated number of times.

Preferably, the relay device further includes reception means for receiving the process rules from another device.

According to a further aspect of the present invention, an information processing method using a plurality of networked relay nodes is provided. The information processing method includes the steps of: setting process rules in the plurality of relay nodes; and, upon receiving a packet, a first relay node included in the plurality of relay nodes determining whether the packet is a process-target packet serving as a target to be processed in the first relay node. The process-target packet includes process-identifying information indicating a content of a process to be executed, and process-target data serving as a target of the process. The information processing method further includes the steps of: when the received packet is the process-target packet in the relay node, executing, by the first relay node, a process corresponding to the process-identifying information included in the packet on the process-target data included in the packet, in accordance with the process rules; determining, the first relay node, a second relay node that is a destination to which a result obtained by processing the process-target data is transferred; transmitting, by the first relay node, the result obtained by processing the process-target data to the second relay node; and, when the received packet is not the process-target packet in the relay node, transferring, by the first relay node, the received packet to another relay node in accordance with route control information.

Preferably, the information processing method further includes the step of: generating, by the first relay node, a packet including the result obtained by processing the process-target data, as the process-target data.

Further preferably, the information processing method further includes the step of: upon receiving the process-target packet at the second relay node from the first relay node, executing, by the second relay node, a process corresponding to the process-identifying information included in the packet on the process-target data included in the packet.

Preferably, the process rules include a definition for repeating a same process a prescribed number of times, and when a packet including designation for repeating a same process a prescribed number of times as the process-identifying information is received, the step of executing includes the step of repeating the process until the process-target packet is received by the designated number of times.

### Advantageous Effects of Invention

According to the present invention, a dataflow architecture with higher scalability, flexibility, and extensibility can be obtained.

### BRIEF DESCRIPTION OF DRAWINGS

FIG. 1 is a schematic diagram showing an overall configuration of an information processing system according to an embodiment of the present invention.

FIG. 2 is a block diagram showing a hardware configuration of a relay device according to the present embodiment.

FIG. 3 is a block diagram showing a hardware configuration of a management device according to the present embodiment.

FIG. 4 is a diagram showing exemplary processing in DFAI (Data-Flow Architecture on the Internet) according to the present embodiment.

FIG. 5 is a schematic diagram showing a control structure implemented in the relay device (relay node) in DFAI according to the present embodiment.

FIG. 6 is a sequence diagram for explaining an initial operation in the information processing system according to the present embodiment.

FIG. 7 is a diagram for explaining a process of generating a dataflow program executed in the management device according to the present embodiment.

FIG. 8 is a schematic diagram for explaining basic functions of the relay device according to the present embodiment.

FIG. 9 is a diagram for explaining update of a packet header portion in a token transfer function according to the present embodiment.

FIG. 10 is a diagram for explaining a tokens synchronizing function according to the present embodiment.

FIG. 11 is a diagram for explaining a data processing function in a node according to the present embodiment.

FIG. 12 is a flowchart showing a process procedure in the relay device (relay node) according to the present embodiment.

FIG. 13 is a diagram for explaining a relay device virtualization technique.

### DESCRIPTION OF EMBODIMENTS

Embodiments of the present invention will be described in details with reference to the figures. It is noted that in the figures the same or corresponding parts are denoted with the same reference signs and a description thereof is not repeated.

### A. Concept

An information processing system according to the present embodiment uses a new method for implementing information processing using a dataflow architecture on a packet-based network (typically, the Internet). In this description, such a new information processing method is referred to as “DFAI (Data-Flow Architecture on the Internet)” from the viewpoint of distinguishing from ordinary dataflow architectures. Although the typical implementation is in the Internet environment and is therefore referred to as “on the Internet,” the environment for implementation is not limited to the Internet, and implementations on a variety of packet-based networks are possible.

In general, dataflow architectures may be mainly classified into a “processor-driven type” in which a process are sequentially driven by a processor and a “token-driven type” in which a process is driven by arrival of a token. DFAI according to the present embodiment may be an architecture classified in the latter “token-driven type.” More specifically, DFAI according to the present embodiment is implemented on a packet-based network composed of relay devices (relay nodes) such as routers mutually connected. Here, each relay device executes processing as described below.

Specifically, in DFAI according to the present embodiment, a packet-based network is used not only for “communication/transfer” but also for “processing” in the dataflow architecture.

Packet-based networks, typically the Internet, have higher scalability to the network scale and higher robustness against failures. Therefore, as described above, a packet-based network can also be used for “processing” to provide higher scalability to the content of information processing (the scale of a program) to be implemented using a dataflow architecture. In addition, a dynamic routing technique at the relay device, a relay device virtualization technique, etc. can be used to provide higher flexibility and extensibility.

### B. System Overview

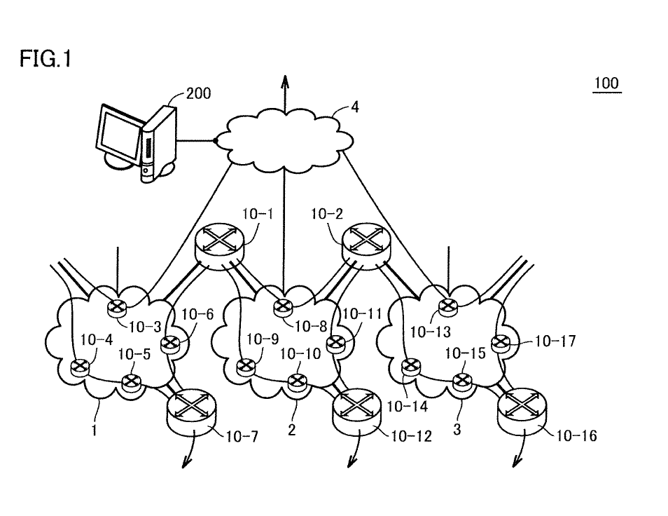

FIG. 1 is a schematic diagram showing an overall configuration of an information processing system according to an embodiment of the present invention. Referring to FIG. 1, an information processing system 100 according to the present embodiment is configured with a packet-based network at the center and includes a plurality of relay devices 10-1, 10-2, . . . , 10-N (hereinafter also collectively referred to as “relay device 10”) and a management device 200.

In the example shown in FIG. 1, a plurality of subordinate networks 1, 2, and 3 exist, and these networks are connected to a main network 4. The relay devices 10 are provided at a network-to-network connection point and any given location depending on a topology in the network and the like.

The relay device 10 has a transfer function of sequentially transferring the received packet to another relay device 10 in accordance with route control information (corresponding to a “routing table (normal packet)” described later). Typically, the relay device 10 is implemented as a router, an L3 (Layer 3) switch, or the like. More specifically, a plurality of relay devices 10 mutually connected sequentially transfer a packet whereby the packet is sent to a target destination.

As described later, the relay device 10 according to the present embodiment is installed with a processing function for implementing DFAI as described later, in addition to the basic transfer function of ordinary routers. The relay device 10 according to the present embodiment can also be implemented with the hardware configuration of the existing router while adding/changing programs executed therein.

The management device 200 executes a variety of processing for implementing DFAI according to the present embodiment. Specifically, the management device 200 acquires a status from each relay device 10 and transmits process rules and the like to each relay device 10. The details of the processing will be described later.

In the following description, terms “relay node” and “management node” may be used in association with the “relay device 10” and the “management device 200,” respectively. These terms “relay node” and “management node” are the concept including both an entity physically connected and an entity logically connected. For example, the relay device virtualization technique as described later can be used to allow a physically single relay device to logically function as a plurality of relay devices. In other words, the terms “relay node” and “management node” focus attention on their functions to be executed depending on some level that identifies each relay device (physical level or logical level). Therefore, a single device may provide a plurality of nodes (virtualization technique). Conversely, a plurality of devices may provide a single node (clustering technique or redundancy technique).

### C. Hardware Configuration of Relay Device

Next, a hardware configuration of the relay device 10 will be described.

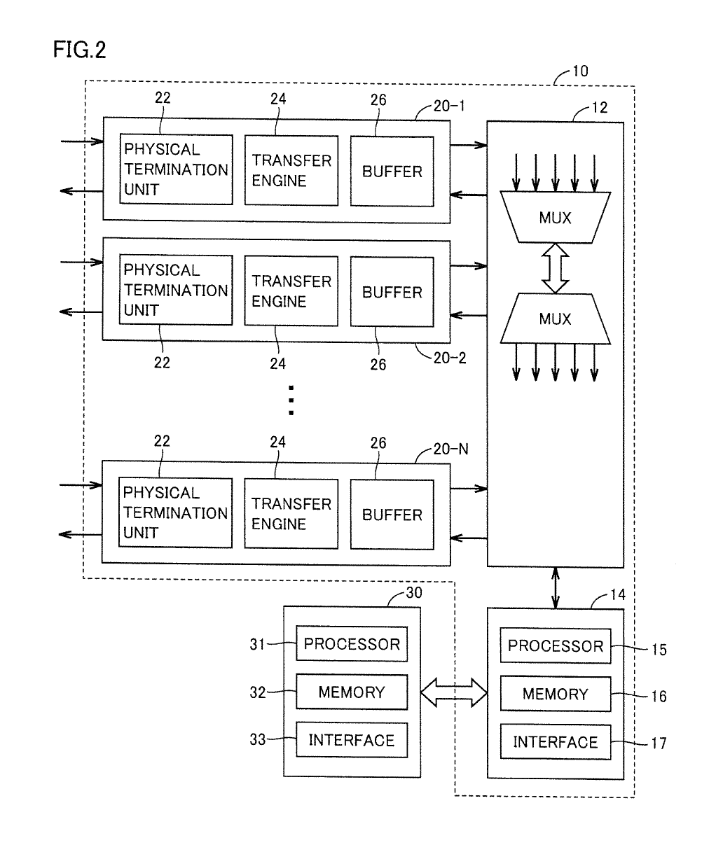

FIG. 2 is a block diagram showing a hardware configuration of the relay device 10 according to the present embodiment. Referring to FIG. 2, the relay device 10 includes a switch unit 12, a transfer processing unit 14, and a plurality of port units 20-1, 20-2, . . . , 20-N (hereinafter also collectively referred to as “port unit 20”).

The switch unit 12 includes a multiplexer and outputs a packet input from one port unit 20 to another port unit 20 in accordance with a command from the transfer processing unit 14. Through such operation, a packet arriving at a port unit 20 is output from a port unit 20 corresponding to a destination.

More specifically, the switch unit 12 includes a physical termination unit 22, a transfer engine 24, and a buffer 26.

The physical termination unit 22, which is a termination of a physical circuit, is physically connected to a network cable of a metal conductor or an optical fiber and receives a packet (a signal indicating a packet) carried over the network cable or outputs a packet (a signal indicating a packet) onto the network cable.

The transfer engine 24 determines a transfer destination for the packet received and decoded at the physical termination unit 22. More specifically, the transfer engine 24 determines a destination by referring to a header portion of the received and decoded packet and determines whether to output the packet from its own port unit 20 or output the packet from another port unit 20 depending on the determined destination. Then, the packet to be output from another port unit 20 is output to the switch unit 12 through the buffer 26.

The buffer 26 is arranged between the transfer engine 24 and the switch unit 12 and temporarily stores (buffers) packets exchanged therebetween. Although the buffer 26 operates on the FIFO (First in First Out) basis, the read/write order of packets temporarily stored in the buffer 26 may be changed in a case where the priority order such as QoS (Quality of Service) is set for packets.

The transfer processing unit 14 gives a variety of commands concerning packet transfer to the switch unit 12 and executes a process for providing DFAI according to the present embodiment. More specifically, the transfer processing unit 14 includes a processor 15, a memory 16, and an interface 17. The processor 15 is formed of a CPU (Central Processing Unit), a DSP (Digital Signal Processor), or the like and executes a process in accordance with a program (instruction codes) stored in the memory 16 or the like. The memory 16 stores a program (instruction codes) executed in the processor 15, route control information required for packet transfer, process rules for implementing DFAI, and the like. The memory 16 may include a volatile storage device such as a DRAM (Dynamic Random Access Memory) and a nonvolatile storage device such as a flash memory. The interface 17 mainly performs data communication with an external processing device 30.

The transfer processing unit 14, or the switch unit 12 and the transfer processing unit 14 may be implemented as dedicated hardware such as an ASIC (Application Specific Integrated Circuit).

The external processing device 30 is connected to the transfer processing unit 14 and mainly executes a process for providing DFAI according to the present embodiment. More specifically, more specifically, the external processing device 30 includes a processor 31, a memory 32, and an interface 33. The processor 31 is formed of a CPU (Central Processing Unit), a DSP (Digital Signal Processor), or the like and executes a process in accordance with a program (instruction codes) stored in the memory 32 or the like. The memory 32 stores a program (instruction codes) executed in the processor 31, process rules for implementing DFAI, and the like. The memory 32 may include a volatile storage device such as a DRAM and a nonvolatile storage device such as a flash memory. The interface 33 mainly performs data communication with the external processing device 30.

It is noted that the external processing device 30 is not an essential component to carry out DFAI according to the present embodiment. More specifically, when the relay device 10 has a processing ability sufficient to execute a process assigned to the relay device 10, the external processing device 30 does not have to be provided. However, when the content of the assigned process is complicated or when a special process is assigned, the process to be executed in the relay device 10 may be entirely or partially executed by the external processing device 30.

### D. Hardware Configuration of Management Device

Next, a hardware configuration of the management device 200 will be described.

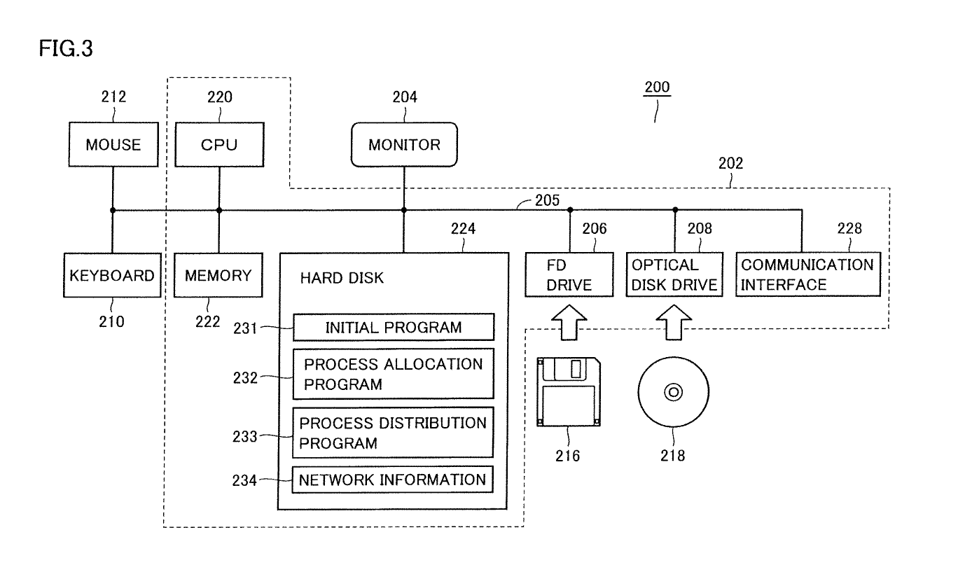

FIG. 3 is a block diagram showing a hardware configuration of the management device 200 according to the present embodiment. Referring to FIG. 3, the management device 200 is typically implemented using a general computer architecture. More specifically, the management device 200 includes a computer main body 202, a monitor 204 as a display device, and a keyboard 210 and a mouse 212 serving as an input device. The monitor 204, the keyboard 210, and the mouse 212 are connected to the computer main body 202 through a bus 205.

The computer main body 202 includes a flexible disk (FD) drive 206, an optical disk drive 208, a CPU (Central Processing Unit) 220, a memory 222, a direct access memory device, for example, a hard disk 224, and a communication interface 228. These parts are also connected with each other through the bus 205.

The flexible disk drive 206 reads and writes information from/to a flexible disk 216. The optical disk drive 208 reads information on an optical disk such as a CD-ROM (Compact Disc Read-Only Memory) 218. The communication interface 228 exchanges data with the outside.

The CD-ROM 218 may be any other medium, for example, such as a DVD-ROM (Digital Versatile Disc) or a memory card as long as the medium can store information such as a program to be installed into the computer main body. In this case, a drive device capable of reading such medium is provided in the computer main body 202. A magnetic tape device which accesses a cassette-type magnetic tape removably attached thereto may be connected to the bus 205.

The memory 222 includes a ROM (Read Only Memory) and a RAM (Random Access Memory).

The hard disk 224 stores an initial program 231, a process allocation program 232, a process distribution program 233, and network information 234.

The initial program 231 is a program serving as a basis of program creation. The hard disk 224 can store a program created by a user as the initial program 231. The initial program 231 may be supplied from a storage medium such as the flexible disk 216 or the CD-ROM 218 or may be supplied from another computer via the communication interface 228.

The process allocation program 232 creates a dataflow program corresponding to the initial program 231, based on the initial program 231. The process allocation program 232 stores information concerning the created dataflow program into the hard disk 224.

The process distribution program 233 transmits the process rules based on the dataflow program created by the process allocation program 232 to each of the relay devices 10.

The network information 234 includes connection information (physical connection and logical connection) of the relay devices 10 mutually connected.

The details of processing by these programs will be described later. The process allocation program 232 and the process distribution program 233 may be supplied from a storage medium such as the flexible disk 216 or the CD-ROM 218 or may be supplied from another computer via the communication interface 228.

The CPU 220 functioning as an arithmetic processing unit executes a process corresponding to each program described above using the memory 222 as a working memory.

The process allocation program 232 and the process distribution program 233 are software executed by the CPU 220 as described above. In general, such software is stored in a storage medium such as the CD-ROM 218 or the flexible disk 216 for distribution, and is read from the storage medium by the optical disk drive 208 or the flexible disk drive 206 to be temporarily stored into the hard disk 224. When the management device 200 is connected to a network, a copy is temporarily made on the hard disk 224 from a server on the network and is then read out from the hard disk 224 onto the RAM in the memory 222 for execution by the CPU 220. When connected to a network, it is possible to directly load into the RAM for execution without storage into the hard disk 224.

The hardware and the operation principle of the computer shown in FIG. 3 are generally known per se. Therefore, the substantial part for implementing the function of the present invention is the software stored in a storage medium such as the flexible disk 216, the CD-ROM 218, or the hard disk 224.

### E. Process Overview

Next, an overview of the processing in DFAI according to the present embodiment will be described.

As described above, DFAI according to the present embodiment is a kind of “token-driven type” dataflow architecture. Therefore, triggered by exchange (transfer) of a packet between routers (or nodes), each process is executed. More specifically, in DFAI according to the present embodiment, information processing of interest is obtained by exchanging a packet that stores information (hereinafter also referred to as “token”) indicating the content of a process to be executed, over the packet-based network composed of routers mutually connected.

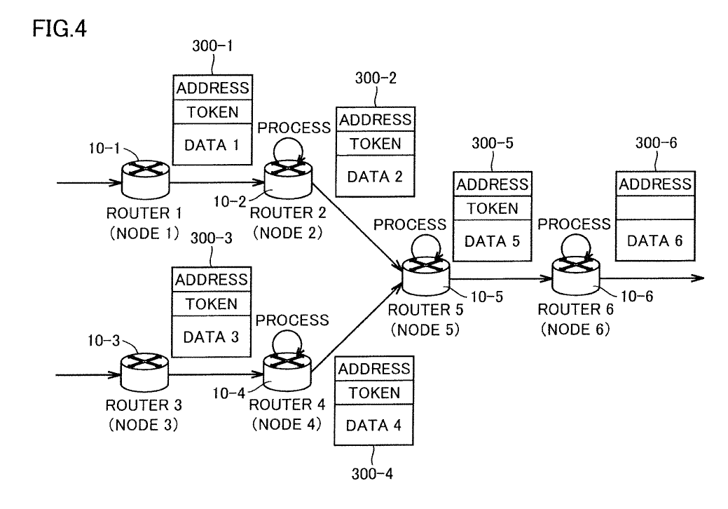

FIG. 4 is a diagram showing exemplary processing in DFAI according to the present embodiment. Referring to FIG. 4, for example, it is assumed that router 1 to router 6 (node 1 to node 6) formed of six relay devices 10-1 to 10-6 are networked. Packets are exchanged between those routers.

It is assumed that packets 300-1, 300-2, . . . , 300-6 shown in FIG. 4 are target packets to be processed (hereinafter also referred to as “process-target packet”) in any one of the relay devices 10 (routers/relay nodes). As described above, the relay device 10 also has the ordinary transfer function, in which a packet to be transferred to a target destination can flow without being processed in the relay device 10 on the network.

Therefore, the relay device 10 selectively extracts a packet for implementing DFAI according to the present embodiment and performs a designated process and, in addition, sequentially transfers other packets (hereinafter also referred to as “normal packet” for the sake of distinction) to a target relay device 10 in accordance with route control information. In other words, each relay device 10 determines whether the received packet is a process-target packet serving as a target to be processed in the relay device 10.

Each process-target packet 300 includes a token as process-identifying information indicating the content of a process to be executed, and process-target data (data 1, data 2, . . . ) serving as a target of the process.

Each relay device 10 stores process rules (which will be detailed later) for executing a process on the received process-target packet 300. Then, upon receiving a process-target packet, each relay device 10 executes a process corresponding to the process-identifying information (token) included in the process-target packet on the process-target data included in the process-target packet, in accordance with the stored process rules.

As for the example shown in FIG. 4, a process-target packet 300-1 is transmitted from router 1 to router 2. This process-target packet 300-1 includes an address that designates router 2, a token indicating a process to be executed in the router 2, and process-target data serving as a target of the process designated by the token.

Then, upon receiving the process-target packet 300-1 from router 1, router 2 determines a process to be executed by referring to the token included in the process-target packet 300-1. For the determination of the process to be executed, the process rules (corresponding to “flow table” described later) are used. Then, router 2 executes a process obtained as a result of determination, on the process-target data (data1) included in the process-target packet 300-1. Then, by referring to the route control information (corresponding to “routing table (process-target packet)” described later), router 2 determines a destination to which the result (data 2) obtained by processing the process-target data (data 1) is transferred.

In the example shown in FIG. 4, router 2 determines a process to be further executed in router 3 as a transfer destination on the result obtained by processing the process-target data. For the determination of the process to be further executed, the process rules (flow table) are used. Then, router 2 generates a process-target packet 300-2. The process-target packet 300-2 includes, as process-target data, the result (data 2) obtained by processing the process-target data (data1) included in the process-target packet 300-1, and includes the content of the process to be further executed, as a token. The process-target packet 300-2 is transferred from router 2 to router 5.

When router 3 transfers a process-target packet 300-3 to router 4 in a similar procedure, router 4 executes a process designated by the token included in the process-target packet 300-3, newly generates a process-target packet 300-4 including data (data 4) obtained as a result of the process, and transfers the process-target packet 300-4 to router 5.

Thereafter, upon receiving the process-target packets 300-2 and 300-4, router 5 newly generates a process-target packet 300-5 including data (data 5) obtained as a result of processing those two process-target packets and transfers the process-target packet 300-5 to router 6. An example in which processes are executed on a plurality of process-target packets 300-2 and 300-4 in router 5 is shown.

Then, upon receiving the process-target packet 300-5, router 6 executes a process designated by the token included in the process-target packet 300-5 and newly generates a packet 300-6 including data 6 obtained as a result. In the example shown in FIG. 4, router 6 corresponds to the final stage of DFAI, and therefore, router 6 does not have to determine a process to be further executed in a transfer destination. Thus, in the packet generated in router 6, a token for designating any process does not exist, or the token is invalidated. In other words, data 6 stored in the packet 300-6 generated by router 6 is the result in DFAI processing shown in FIG. 4.

In the actual DFAI, it is understood that even more processes are successively executed in many cases, and information processing of interest is achieved by sequentially transferring packets between even more relay devices 10. Even during execution of the same DFAI, a process-target packet may be received multiple times at the same relay device (or relay node). For example, in a manner in which a process-target packet is circularly transferred between a plurality of relay devices 10, the process-target packet is transferred multiple times to each relay device 10 even during execution of DFAI at a time.

As described above, the basic concept of DFAI according to the present embodiment lies in that the dataflow network is mapped on the packet-based network. In other words, a node in the dataflow architecture is associated with a router (relay node) in the packet-based network. Similarly, a “token” in the dataflow architecture is associated with a “packet” in the packet network.

With the configuration in this manner, packet exchange in the packet-based network is not performed for end-to-end “communication” but can be used for “processing” in the network.

### F. Control Configuration of Relay Device

Next, a control configuration in the relay device (relay node) will be described.

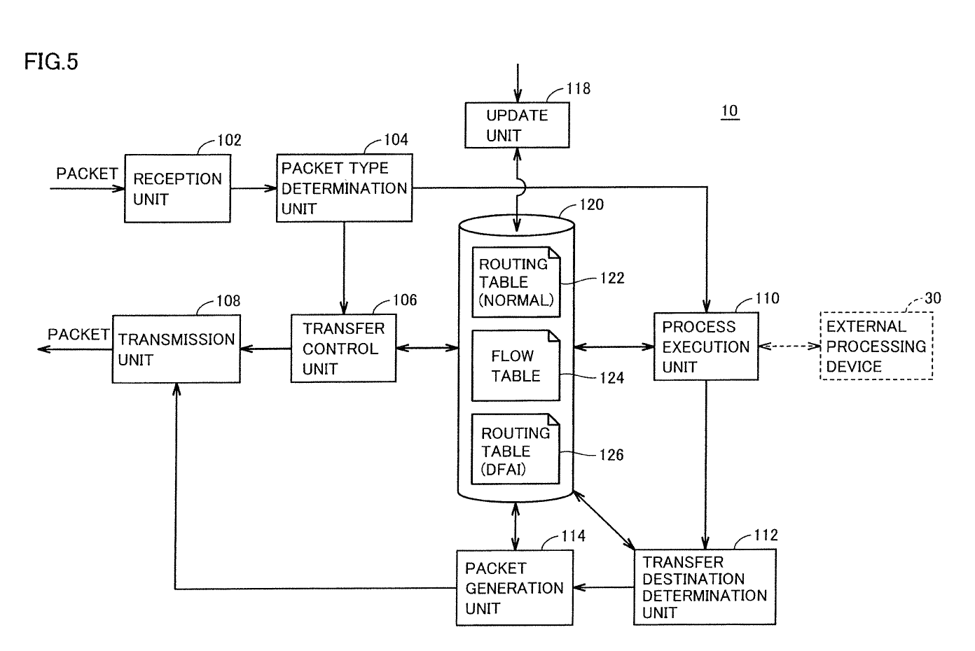

FIG. 5 is a schematic diagram showing a control structure implemented in the relay device 10 (relay node) in DFAI according to the present embodiment. Referring to FIG. 5, the relay device 10 includes, as its control structure, a reception unit 102, a packet type determination unit 104, a transfer control unit 106, a transmission unit 108, a process execution unit 110, a transfer destination determination unit 112, an update unit 118, and a data storing unit 120.

At least a routing table (normal) 122, a flow table 124, and a routing table (DFAI) 126 are stored in the data storing unit 120.

Of the control structure, each unit excluding the data storing unit 120 is typically implemented by the processor 15 of the transfer processing unit 14 executing a program, and the data storing unit 120 is implemented by allocating a prescribed area in the memory 16 of the transfer processing unit 14. The control structure shown in FIG. 5 may be entirely or partially implemented by hardware.

The reception unit 102 detects a packet received at the relay device 10 (relay node). Information of the received packet detected by the reception unit 102 is output to the packet type determination unit 104.

The packet type determination unit 104 determines whether the received packet is a process-target packet serving as a target to be processed in its own device (its own node). In other words, the packet type determination unit 104 determines whether each received packet is a normal packet or a process-target packet. The packet type is determined based on information included in a payload portion of the packet. Then, the received packet determined as a normal packet is output to the transfer control unit 106, and the received packet determined as a process-target packet is output to the process execution unit 110.

The transfer control unit 106 executes a process for transferring the received packet to another relay device 10 (relay node) in accordance with the route control information. More specifically, by referring to the routing table (normal) 122 stored in the data storing unit 120, the transfer control unit 106 updates the header portion (destination information) of the received packet with the interface address (typically, MAC (Media Access Control) address) of the relay device 10 as a transfer destination. Then, the transfer control unit 106 outputs the packet with the updated destination to the transmission unit 108.

Upon receiving the process-target packet, the process execution unit 110 executes a process corresponding to the process-identifying information (token) included in the packet, on the process-target data included in the packet, in accordance with the flow table 124 as the process rules. More specifically, the process execution unit 110 specifies a process corresponding to the value of “flow ID” included in the payload portion of the process-target packet by referring to the flow table 124 and executes the process on the “data” included in the payload portion of the process-target packet. Here, the flow table 124 is process rules and is stored in the data storing unit 120 serving as storage means.

The process execution unit 110 may allow the external processing device 30 to execute a process and obtains the result thereof, depending on the content of the process and the amount of processing.

The transfer destination determination unit 112 determines a destination to which the result obtained by the process execution unit 110 processing the process-target data included in the process-target packet is transferred. More specifically, the transfer destination determination unit 112 determines the destination corresponding to the value of “flow ID” included in the process-target packet, as a transfer destination, by referring to the routing table (DFAI) 126 stored in the data storing unit 120.

The packet generation unit 114 generates a packet including the result obtained by the process execution unit 110 processing the process-target data. Here, the packet generation unit 114 inserts the address of the transfer destination determined by the transfer destination determination unit 112, into the header portion of the packet.

The transmission unit 108 sends out the packet output from the transfer control unit 106 or the packet generated by the packet generation unit 114 onto the network.

The update unit 118 receives the flow table 124 as the process rules from the management device 200 and updates the data storing unit 120 using the received flow table 124.

### G. Functions of Management Device

Next, functions provided by the management device 200 according to the present embodiment will be described.

The management device 200 has a function of allocating information processing of interest input by a user to a plurality of relay devices 10 (relay nodes) and a function of transmitting the process rules to each of a plurality of relay devices 10 (relay nodes) based on the allocation result.

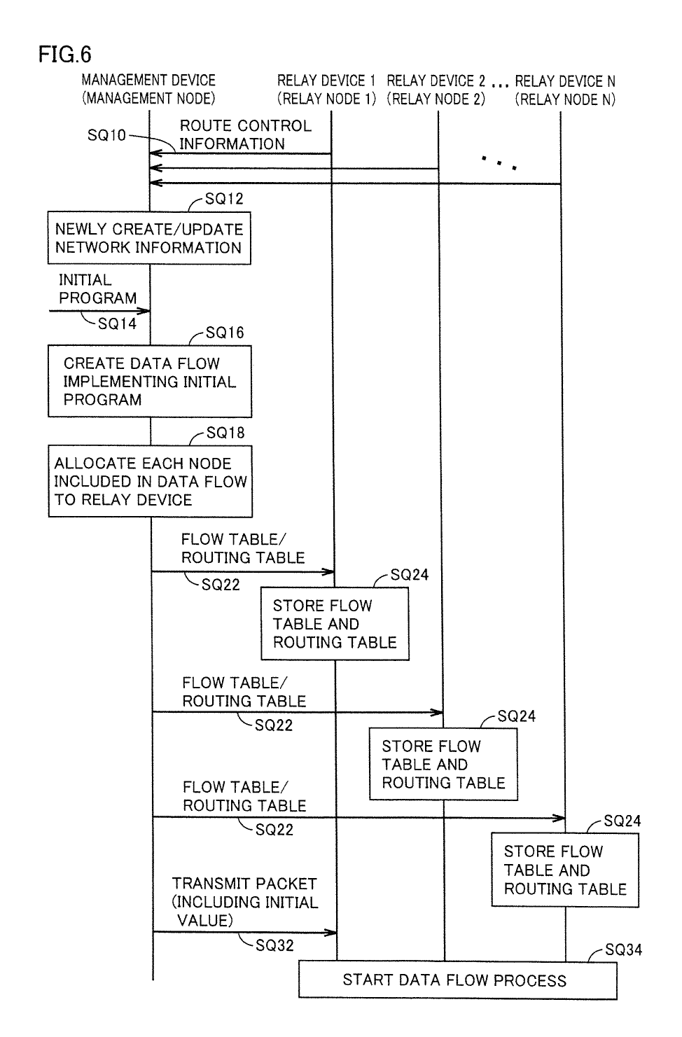

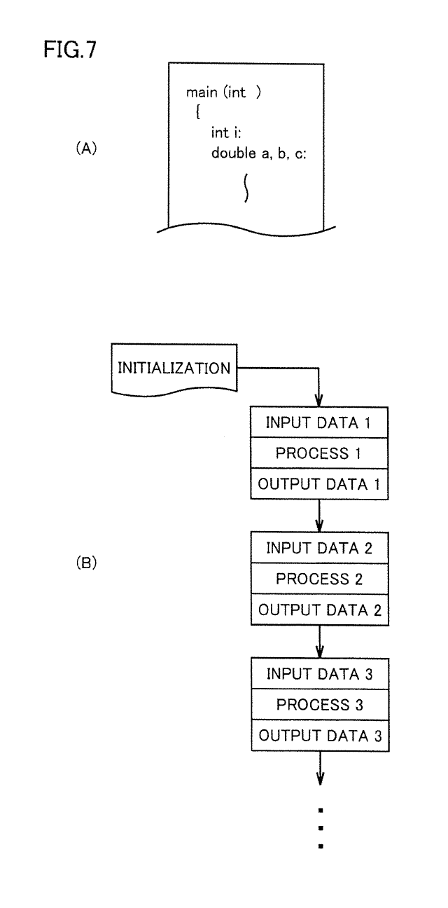

FIG. 6 is a sequence diagram for explaining an initial operation in the information processing system 100 according to the present embodiment. FIG. 7 is a diagram for explaining a process of generating a dataflow program executed in the management device 200 according to the present embodiment.

Referring to FIG. 6, the management device 200 accesses one or more relay devices 10 (relay nodes) regularly or in response to a prescribed event and acquires information of the network to which a plurality of relay devices 10 are mutually connected (the network information 234 shown in FIG. 3).

More specifically, the management device 200 acquires the route control information transmitted from each of the relay devices (relay nodes) 1, 2, . . . , N (sequence SQ10) and then newly creates network information 234 or updates the contents of the network information 234 stored in the device itself (sequence SQ12).

Thereafter, the management device 200 accepts an initial program (sequence SQ14) and then creates a data flow for implementing the initial program (sequence SQ16).

Referring to FIG. 7, for example, a data flow as shown in FIG. 7(B) is generated by analyzing a program written with codes as shown in FIG. 7(A). It is not necessary to embody in a block format as shown in FIG. 7(B).

The data flow shown in FIG. 7(B) is configured with a plurality of nodes mutually connected. Input data, contents of a process, and output data are typically defined in each node.

The management device 200 allocates each node in the dataflow architecture shown in FIG. 7(B) to the actual relay device 10 (relay node) in the packet-based network. Data exchanged between the nodes shown in FIG. 7(B) corresponds to data included in a packet exchanged between the actual relay devices 10 (relay nodes). Although FIG. 7(B) typically shows one data flow, a plurality of data flows may be generated in parallel. In this case, they can be distinguished from each other with different values of identification information (flow IDs).

Referring to FIG. 6 again, the management device 200 allocates the nodes included in the data flow created in sequence SQ16 to the relay devices 10 (sequence SQ18). Furthermore, the management device 200 transmits the flow table 124 and the routing table (DFAI) 126 to the relay devices 10 (relay nodes) based on the allocation result in sequence SQ18 (sequence SQ22).

Each of the relay devices 10 (relay nodes) stores the received flow table 124 and routing table (DFAI) 126 (sequence SQ24).

When the setting of the flow table 124 and the routing table (DFAI) 126 in the relay devices 10 (relay nodes) is completed, the management device 200 transmits initial data for triggering the dataflow architecture, that is, a packet including an initial value, to the relay device 10 (relay node) corresponding to the initial node of the data flow (sequence SQ32). Then, while the relay devices 10 (relay nodes) sequentially transfer packets, a series of information processing (calculation) is started (sequence SQ34).

The result of a series of information processing (calculation) may be programmed so as to be returned to the management device 200 or may be programmed so as to be output to another device (node).

### H. Basic Functions of Relay Device

The relay device 10 (relay node) for implementing DFAI according to the present embodiment has the following four basic functions:

(1) token transfer function

(2) tokens synchronizing function

(3) data processing function

(4) output node determination function.

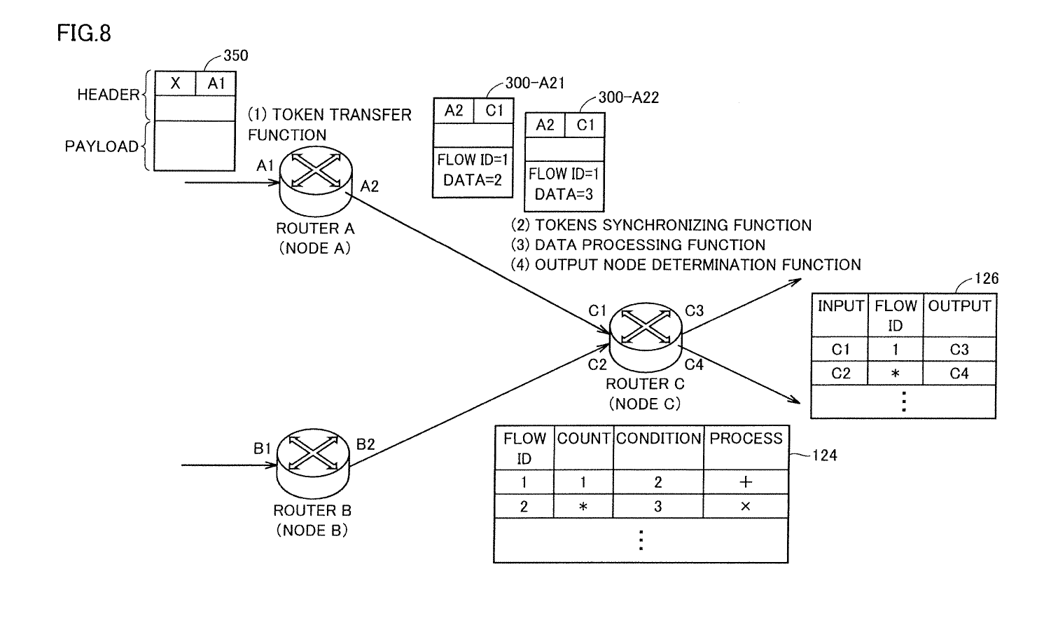

FIG. 8 is a schematic diagram for explaining the basic functions of the relay device 10 according to the present embodiment. Referring to FIG. 8, each of these functions will be detailed below.

(h1. Token Transfer Function)

One of the basic functions of the relay device 10 according to the present embodiment is the “token transfer function.” This token transfer function is a function of transferring the received process-target packet to another relay device in accordance with the route control information. The token transfer function is basically the same as the routing function as in ordinary routers. However, the destination set in each packet, etc. is directed to DFAI according to the present embodiment.

The term “token,” which is a term mainly used in the dataflow architectures, is described in association with DFAI according to the present embodiment for the sake of facilitating the understanding, and is used in parallel.

The relay device 10 transfers a process-target packet (corresponding to the token in the dataflow architecture) received from the relay device (relay node) at the previous stage, to the relay device (relay node) located at the subsequent stage.

More specifically, the relay device 10 (relay node) receives some packet and then specifies the relay device (relay node) associated with the node located in the next place in the dataflow architecture. Then, the relay device 10 (relay node) embeds the address (the next node address) of the node located in the next place into the header portion of the received packet and also embeds information (token ID and process-target data) corresponding to the token in the dataflow architecture into the payload portion of the received packet.

The packet received from the relay device 10 (relay node) located at the previous stage may be either a normal packet or a process-target packet.

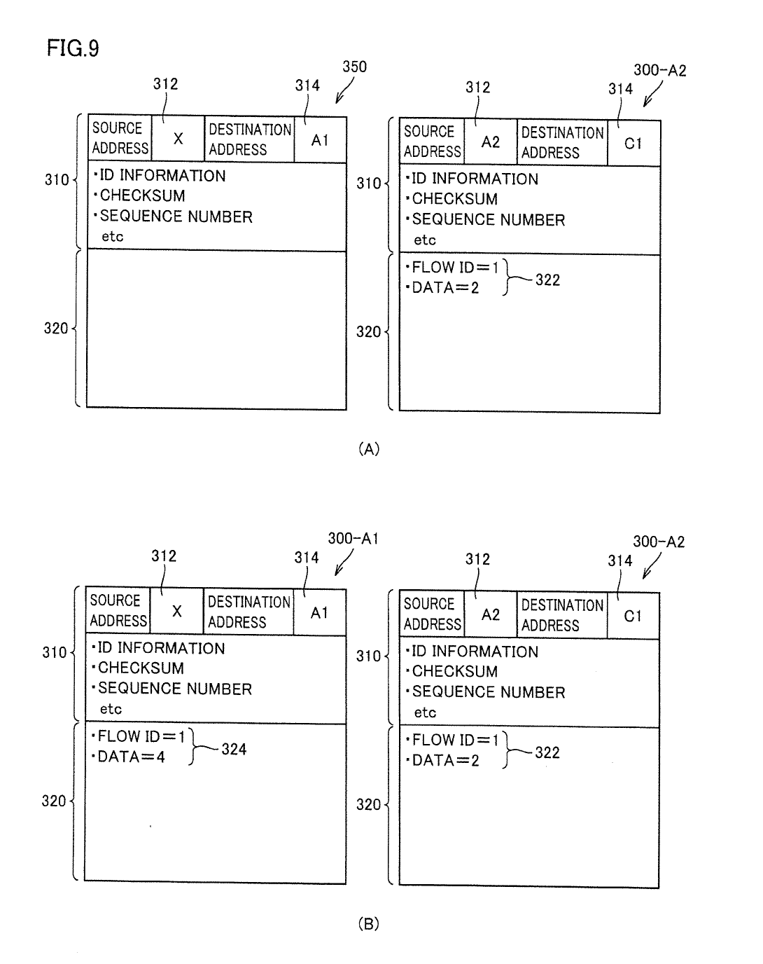

FIG. 9 is a diagram for explaining update of the packet header portion in the token transfer function according to the present embodiment.

As shown in FIG. 9(A), it is assumed that any one relay device 10 (relay node) receives a normal packet 350. This normal packet 350 includes a header portion 310 and a payload portion 320. Then, the header portion 310 includes an area 312 for storing a source address and an area 314 for storing a destination address. The header portion 310 also stores information including ID information, checksum, sequence number, etc. (of the packet itself) in addition to the source and destination addresses.

When any one relay device 10 (relay node) receives the normal packet 350, the relay device 10 updates the address information of the header portion 310. The example shown in FIG. 9(A) shows a process in a case where router A (node A) shown in FIG. 8 updates the address information of the header portion 310. More specifically, router A (node A) sets “A2” that is an interface address used for sending out packets in its own node, as a source address, in the area 312, and sets “C1” that is an interface address of router C (node C) corresponding to the next node in the set data flow, in the area 314.

With the header portion updated in this manner, the normal packet 350 received by router A (node A) is transferred as a process-target packet 300-A2 from router A (node A) to router B (node B) at the subsequent stage.

In other words, in the packet exchange (transfer) process in the normal packet-based network, end-to-end communication is performed, so that a destination host address is set as a destination address in the header portion 310 of the packet. By contrast, in DFAI according to the present embodiment, the address of the next node (the subsequent stage) is set as the destination address in the header portion 310 of the packet in accordance with the target data flow.

In this manner, the addresses of the routers (nodes) corresponding to the dataflow are sequentially set as destination addresses, whereby hop-by-hop communication between nodes, rather than end-to-end communication between hosts, is implemented. Then, the dataflow architecture is implemented using the hop-by-hop communication between nodes.

Information such as a process (token) for implementing DFAI is stored in the payload portion 320 of a packet. Therefore, as shown in FIG. 9(A), the relay device 10 (relay node) corresponding to the first node in the data flow may update the payload portion 320.

FIG. 9(B) further shows exemplary processing in a case where router A (node A) shown in FIG. 8 receives the process-target packet 300-A1 and then executes some process on the process-target data included in the process-target packet 300-A1 with the data processing function as described later.

In the example shown in FIG. 9(B), the source address (the value in the area 312) and the destination address (the value in the area 314) held in the header portion 310 are updated, and in addition, the contents of the token is updated in accordance with the process result, in the header portion 310. In other words, a description 324 of the payload portion 320 of the process-target packet 300-A1 is updated with a description 322. This process will be detailed in the description of (3) data processing function.

(h2. Tokens Synchronizing Function)

Next, the tokens synchronizing function will be described.

For example, given a process in which a plurality of process results are summed up, it is necessary to wait until process-target packets each having a process result stored therein are received over multiple times and to sequentially integrate them. In other words, the data flow to be processed may include a definition for repeating the same process a prescribed number of times. Then, when a packet including designation for repeating the same process a prescribed number of times as a flow table is received, the relay device 10 (relay node) according to the present embodiment repeats the process until the process-target packet is received by the designated number of times.

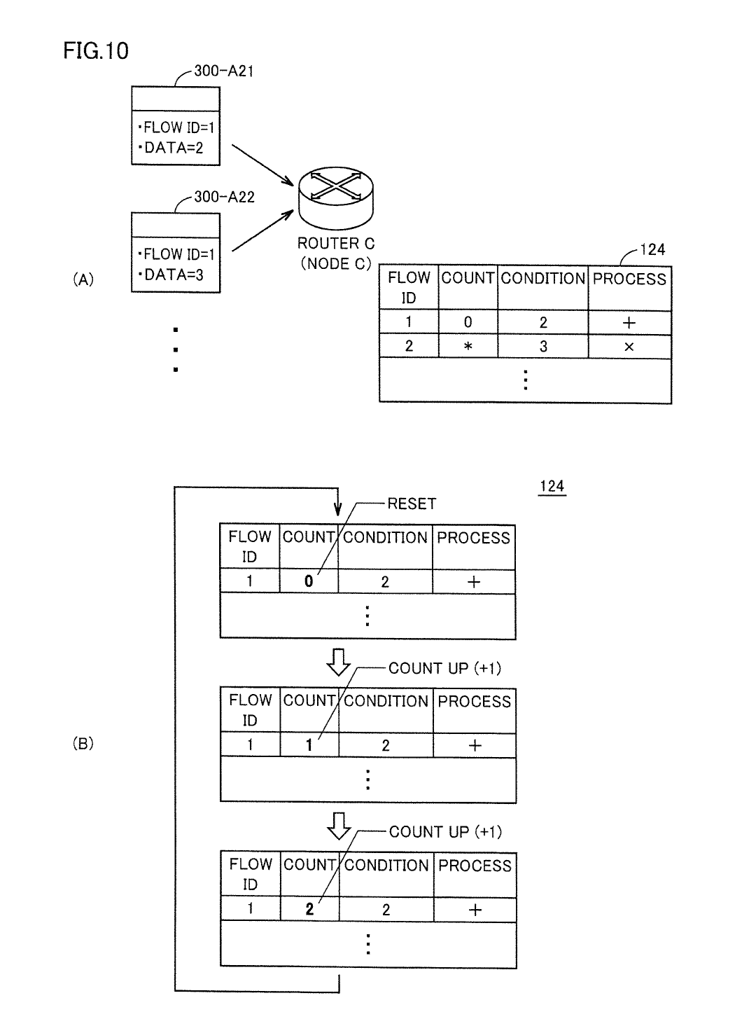

FIG. 10 is a diagram for explaining the tokens synchronizing function according to the present embodiment.

Referring to FIG. 10(A), in order to implement the tokens synchronizing function according to the present embodiment, “count” and “condition” fields are provided for each “flow ID” in the flow table 124 stored by each relay device 10 (relay node). The value of the “condition” indicates the number of times the process should be repeated for the corresponding “flow ID.” The value of the “count” indicates the number of times the process has been repeated up to each point of time. In other words, in the flow table 124, the values of “flow ID,” “count,” “condition,” and “process” are set for each process that includes a process requiring the tokens synchronizing function. Here, the value set in “count” (the repetition count) is determined depending on the set dataflow program.

A unique flow ID is allocated to a process-target packet (token) requiring synchronization. Then, the relay device 10 (relay node) refers to the flow table 124 so that the process is repeated a prescribed number of times.

As for the more specific process procedure, referring to FIG. 10(B), first, the relay device 10 (relay node) resets the “count” field of the flow table 124 to zero. Thereafter, when the relay device 10 (relay node) receives a process-target packet having any one of flow IDs described in the flow table 124, the process-target data included in the received process-target packet is temporarily stored, and the value of “count” corresponding to the same flow ID as the received process-target packet is incremented (counted up) by one in the flow table 124.

In the actual implementation, upon receiving some process-target packet, the relay device 10 (relay node) acquires the value of “flow ID” included in the payload portion of the process-target packet and searches the flow table 124 for an entry that matches the acquired value of “flow ID.” Then, if an entry that matches the acquired value of “flow ID” is found, the value of “count” corresponding to the “flow ID” is incremented (counted up) by one.

By repeating this process a prescribed number of times, the value of “count” corresponding to the “flow ID” is sequentially increased. Then, when the value of “flow ID” increases and agrees with the value of the corresponding “condition,” it is determined that the required process-target packets have already been received. Then, the relay device 10 (relay node) thereafter does not acquire a process-target packet.

Instead, execution of the process corresponding to the “flow ID” is triggered, and the process is executed on the process-target packets acquired beforehand over the prescribed number of times.

In other words, when the value of “count” indicating the number of received process-target packets (tokens) becomes equal to the value of “condition” (the number of process-target packets required for the synchronized process), the relay device 10 (relay node) triggers the corresponding data processing function and resets the corresponding “count” to zero.

(h3. Data Processing Function)

As described above, when the condition defined in the flow table 124 is satisfied to trigger execution of a process, the processor 15 (see FIG. 2) provided in the relay device 10 or the processor 31 (see FIG. 2) provided in the external processing device 30 is used to execute the process designated by the flow ID on the process-target data included in the payload portion 320 of the received process-target packet. Here, when the processor in the relay device 10 is used, the process is implemented with hardware substantially similar to that of the process in ordinary routers. However, when the external processing device 30 is used, it is necessary to store the process-target packet in any storage area and to temporarily hook the packet transfer process.

The use of the processor in the relay device 10 or the processor in the external processing device 30 may be selected depending on the process to be executed. For example, when the process requires real-time performance or when the process is a simple process, the process can be executed by the processor in the relay device 10. On the other hand, when the process does not require real-time performance or the process is a complicated process, the process can be executed by the processor in the external processing device 30. In this manner, higher speed, flexibility, and extensibility can be obtained by selecting a processor to be enabled.

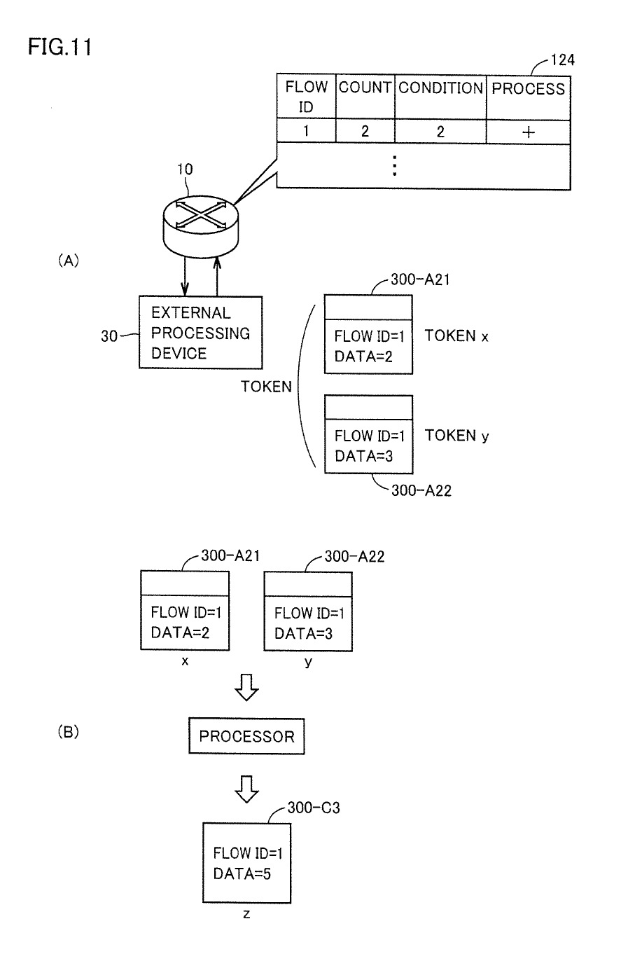

FIG. 11 is a diagram for explaining the data processing function in a node according to the present embodiment.

Referring to FIG. 11(A), “+” (addition process) is defined as data processing for the “flow ID”=“1” in the flow table 124 stored by the relay device 10 (relay node), by way of example. Furthermore, “condition”=“2” is set, and the tokens synchronizing function as described above is set. In other words, in the flow table 124 shown in FIG. 11(A), data processing of adding up, in total, two process-target data held in the payload portions is defined for two process-target packets with the “flow ID”=“1.”

Here, it is assumed that the relay device 10 receives two process-target packets 300-A21 and 300-A22 (tokens). Then, “data”=“2” held in the payload portion of the process-target packet 300-A21 (token x) and “data”=“3” held in the pay load portion of the process-target packet 300-A22 (token y) are extracted for execution of data processing.

More specifically, as shown in FIG. 11(B), token x and token y are sent to the processor, so that data processing set with “flow ID”=“1” is executed. Then, a new token z including the result obtained through this data processing is generated. After the output node is determined, this token z is output to the relay device 10 (relay node) at the subsequent stage as a new process-target packet as described later.

Although FIG. 11 illustrates operation in a case where the same process is repeated multiple times on a plurality of process-target packets (tokens), operation may be such that a particular process is carried out on one process-target packet.

(h4. Output Node Determination Function)

After the data processing as described above is executed, the relay device 10 (relay node) determines a destination to which the result obtained through data processing is transferred. This output node determination function is implemented using the routing table (DFAI) 126 as shown in FIG. 8.

Specifically, referring to FIG. 8 again, the routing table (DFAI) 126 includes an “input” field indicating an input interface receiving a process-target packet, a “flow ID” field, and an “output” field indicating an output interface.

Upon receiving some process-target packet, the relay device 10 (relay node) searches the router table based on the address of the input interface at which the process-target packet arrives, and the flow ID entered in the process-target packet (token), and determines the address of the output interface.

For example, in the example of the routing table (DFAI) 126 shown in FIG. 8, as for “input,” in total, two entries “C1” and “C2” exist. In other words, the process-target packet received at the input interface “C1” with the “flow ID” “1” is sent out to the network from the output interface “C3” after data processing.

Here, “*” (asterisk) means “don't care,” and in the example shown in FIG. 8, the process-target packet received at the input interface “C2” is sent out from the output interface C4 to the network after data processing, regardless of its value of “flow ID.”

As for the search process in the routing table (DFAI) 126, the longest match rule is utilized in which the one including a longer character string is selected in a similar manner as in a general routing table search process.

When a plurality of entries are written as output interfaces, the relay device 10 (relay node) replicates a packet to be sent out from all the interfaces written therein and outputs the packets from the output interfaces.

The flow table 124 is determined by a dataflow program. Therefore, dynamic programming during data processing can be implemented by dynamically updating the routing table (performing dynamic routing).

Furthermore, reverse propagation that is required in error feedback of calculation results can be obtained by reversely looking up the routing table (DFAI) 126.

When an entry of the routing table is asymmetrical (when the designation of the input interface is “* (asterisk)”), reverse look-up cannot be performed directly. Then, when there is a match with an asymmetrical entry of the routing table, token sending history is stored. This enables reverse look-up even in an asymmetrical routing table.

### I. Process Flow

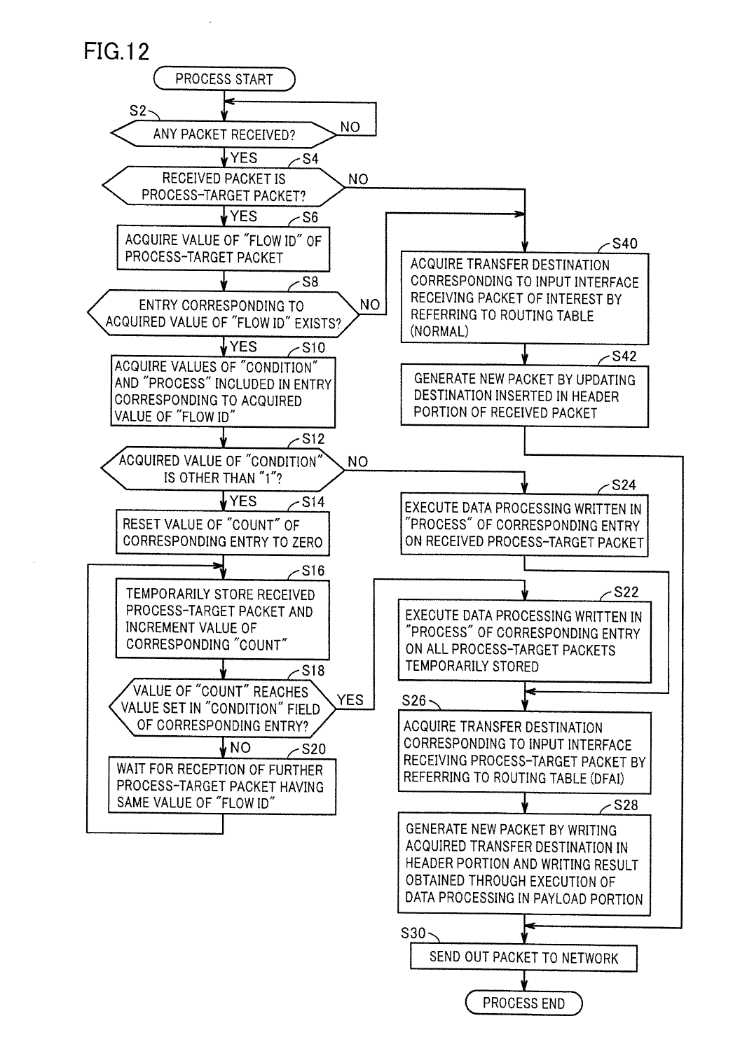

Next, a process flow in the relay device 10 (relay node) according to the present embodiment will be summarized. FIG. 12 is a flowchart showing a process procedure in the relay device 10 (relay node) according to the present embodiment.

Referring to FIG. 12, the relay device 10 determines whether any packet is received (step S2). If no packet is received (NO in step S2), the process in step S2 is repeated.

If any packet is received (YES in step S2), the relay device 10 determines whether the received packet is a process-target packet (step S4). More specifically, the relay device 10 determines whether the received packet is a target packet to be subjected to any data processing in the device itself.

If the received packet is not a process-target packet (NO in step S4), that is, if the received packet is a normal packet, the process proceeds to step S40.

On the other hand, if the received packet is a process-target packet (YES in step S4), the relay device 10 acquires the value of “flow ID” written in the payload portion 320 (see FIG. 9) of the process-target packet (step S6). Then, the relay device 10 determines whether an entry corresponding to the value of “flow ID” acquired in step S6 exists by referring to the flow table 124 (step S8).

If an entry corresponding to the acquired value of “flow ID” does not exist (NO in step S8), the relay device 10 determines that data processing for the process-target packet is not required in the device itself, and the process then proceeds to step S40.

On the other hand, if an entry corresponding to the acquired value of “flow ID” exists (YES in step S8), the relay device 10 acquires the value in the “condition” field and the value in the “process” field that are included in the entry corresponding to the acquired value of “flow ID” (step S10). In other words, the relay device 10 specifies the content of data processing to be executed on the process-target process of interest in accordance with the flow table 124 as the process rules.

Then, the relay device 10 determines whether the value of “condition” acquired in step S10 is other than “1” (step S12).

If the value of “condition” acquired in step S10 is other than “1” (YES in step S12), the relay device 10 determines that the tokens synchronizing function is set enabled, and resets the value in the “count” field of the corresponding entry to zero in the flow table 124 (step S14).

Then, the relay device 10 temporarily stores the received process-target packet and increments the value of the corresponding “count” by one (step S16). Then, the relay device 10 determines whether the incremented value of “count” reaches the value set in the “condition” field of the corresponding entry (step S18).

If the incremented value of “count” does not reach the value of “condition” of the corresponding entry (NO in step S18), reception of an additional process-target packet having the same “flow ID” as the value of “flow ID” of the corresponding entry is awaited (step S20). Then, the process after step S16 is repeated.

If the incremented value of “count” reaches the value of “condition” of the corresponding entry (YES in step S18), data processing written in the “process” field of the corresponding entry is executed on all the process-target packets temporarily stored (step S22).

On the other hand, if the value of “condition” acquired in step S10 is “1” (NO in step S12), the relay device 10 determines that the tokens synchronizing function is set disabled, and executes data processing written in the “process” field of the corresponding entry on the received process-target packet (step S24).

After execution of step S22 or step S24, the relay device 10 acquires a transfer destination corresponding to the input interface that receives the process-target packet of interest by referring to the routing table (DFAI) 126 (step S26).

Thereafter, a new packet is generated by writing the transfer destination acquired in step S26 in the header portion and by writing the result obtained by executing data processing in step S22 or step S24 in the payload portion (step S28).

On the other hand, in step S40, the relay device 10 determines that data processing on the process-target packet is not necessary in the device itself, and acquires a transfer destination corresponding to the input interface that receives the packet of interest by referring to the routing table (normal) 122. Then, the relay device 10 generates a new packet by updating the destination inserted in the header portion of the received packet with the transfer destination acquired in step S40 (step S42).

Finally, the relay device 10 sends out the packet generated in step S28 or step S42 to the network (step S30). The process then ends.

### J. Other Embodiments

### (1) Virtualization Technique

In the foregoing description, basically, the physical address and the logical address of the relay device 10 are in one-to-one relationship. However, one relay device 10 can be treated as a plurality of logical relay nodes. This method is also referred to as a relay device virtualizing technique.

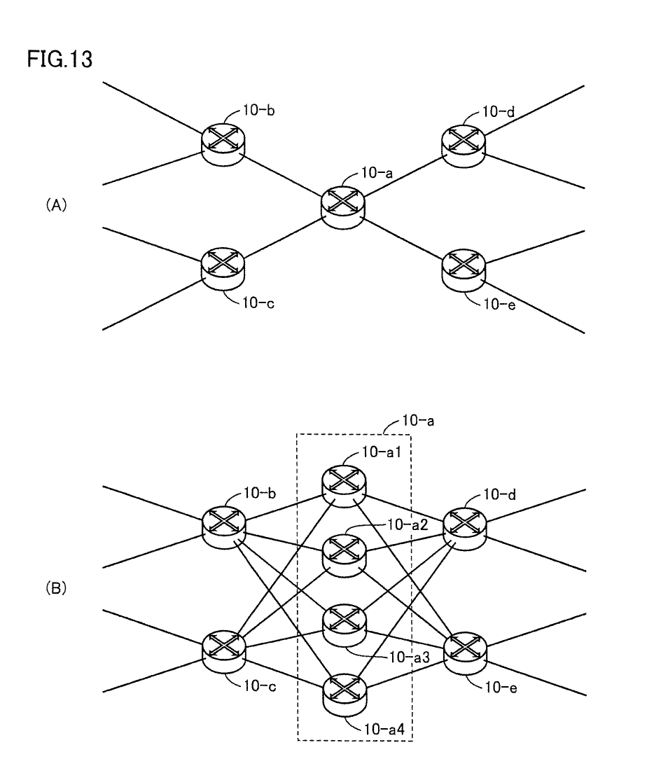

FIG. 13 is a diagram for explaining the relay device virtualization technique. FIG. 13(A) shows an example of a physical network of the relay devices 10. FIG. 13(B) shows an example of a logical network provided by the relay devices 10. More specifically, in the example shown in FIG. 13(B), a relay device 10-a is virtualized and therefore can be treated logically as four relay nodes 10-a1, 10-a2, 10-a3, and 10-a4.

The use of such virtualization technique can further enhance scalability, flexibility, and extensibility.

### (2) Advanced Dataflow Architecture

With DFAI according to the present embodiment, in addition to similar processing as in the ordinary dataflow architecture, a process according to “advanced dataflow architecture” can also be obtained.

The “advanced dataflow architecture” can use a function of dynamically modifying a program during process execution (dynamic programming) and a learning function based on error feedback of computation results (self-organizing programming), in addition to the functions of ordinary dataflow architectures.

### K. Advantages

In the information processing system according to the present embodiment, information processing based on the dataflow architecture can be provided while keeping the function as a normal relay device (relay node). Therefore, the cost necessary for implementing the dataflow architecture can be reduced.

A normal network includes a number of relay devices (routers or L3 switches), which can be used to provide an execution environment for the dataflow architecture with higher scalability, flexibility, and extensibility.

The advanced dataflow architecture can be used to use the function of dynamically modifying a program during process execution (dynamic programming), the learning function based on error feedback of computation results (self-organizing programming), and the like.

The embodiment disclosed here should be understood as being illustrative rather than being limitative in all respects. The scope of the present invention is shown not in the foregoing description but in the claims, and it is intended that all modifications that come within the meaning and range of equivalence to the claims are embraced here.

### REFERENCE SIGNS LIST

1, 2, 3 subordinate network, 4 main network, 10 relay device (relay node), 12 switch unit, 14 transfer processing unit, 15, 31 processor, 16, 32, 222 memory, 17, 33 interface, 20 port unit, 22 physical termination unit, 24 transfer engine, 26 buffer, 30 external processing device, 100 information processing system, 102 reception unit, 104 packet type determination unit, 106 transfer control unit, 108 transmission unit, 110 process execution unit, 112 transfer destination determination unit, 114 packet generation unit, 118 update unit, 120 data storing unit, 124 flow table, 200 management device, 202 computer main body, 204 monitor, 205 bus, 206 drive, 208 optical disk drive, 210 keyboard, 212 mouse, 218 ROM, 220 CPU, 224 hard disk, 228 communication interface, 231 initial program, 232 process allocation program, 233 process distribution program, 234 network information, 300 process-target packet, 310 header portion, 320 payload portion.

1. An information processing system comprising:
a plurality of networked relay nodes; and
a management node,
each of said relay nodes including
a transfer unit for transferring a received packet to another relay node in accordance with route control information,
a storing unit for storing process rules,
determination logic for determining whether the received packet is a process-target packet serving as a target to be processed in the relay node,
synchronization logic for waiting for arrival of a plurality of process-target packets required for execution of said process rules, said process-target packet including process-identifying information indicating a content of a process to be executed, and process-target data serving as a target of the process,
processing logic for, when said process-target packet is received at the relay node, executing a process corresponding to said process-identifying information included in the packet on said process-target data included in the packet, in accordance with said process rules, and
determination logic for determining a destination to which a result obtained by processing the process-target data is transferred,
said management node including
allocation logic for allocating information processing of interest to said plurality of relay nodes,
transmission logic for transmitting said process rules to said plurality of relay nodes, based on the allocation result,
reception logic for receiving a result in said processing logic from said plurality of relay nodes, and
change logic for changing said route control information of said relay node based on the result obtained by said reception logic.

2. The information processing system according to claim 1, wherein each of said relay nodes further includes generation logic for generating a packet including the result obtained by processing said process-target data, as said process-target data.

3. The information processing system according to claim 1 or 2, wherein
said process rules include a definition for repeating a same process a prescribed number of times, and
when a packet including designation for repeating a same process a prescribed number of times as said process-identifying information is received, said processing logic repeats the process until the process-target packet is received by the designated number of times.

4. The information processing system according to claim 1, wherein
each of said relay nodes is configured to store said process-identifying information included in said process-target packet and route information determined by said transfer unit, and
each of said relay nodes includes reverse transfer logic for transferring said process-target packet in a reverse direction through a path through which said process-target packet passes, and a change function of changing said process rules in the relay node, based on said process-identifying information and said process-target data included in the packet.

5. A relay device directed to information processing using a plurality of networked relay nodes, comprising:
a transfer unit for transferring a received packet to another relay device in accordance with route control information;
a storing unit for storing process rules;
determination logic for determining whether the received packet is a process-target packet serving as a target to be processed in the relay device, said process-target packet including process-identifying information indicating a content of a process to be executed, and process-target data serving as a target of the process;
processing logic for, when said process-target packet is received at the relay device, executing a process corresponding to said process-identifying information included in the packet on said process-target data included in the packet, in accordance with said process rules; and
determination logic for determining a destination to which a result obtained by processing said process-target data is transferred.

6. The relay device according to claim 5, further comprising generation logic for generating a packet including the result obtained by processing said process-target data, as said process-target data.

7. The relay device according to claim 5 or 6, wherein
said process rules include a definition for repeating a same process a prescribed number of times, and
when a packet including designation for repeating a same process a prescribed number of times as said process-identifying information is received, said processing logic repeats the process until the process-target packet is received by the designated number of times.

8. The relay device according to claim 5 or 6, further comprising a reception unit for receiving said process rules from another device.

9. An information processing method using a plurality of networked relay nodes, comprising:
setting process rules in said plurality of relay nodes;
upon receiving a packet, a first relay node included in said plurality of relay nodes determining whether the packet is a process-target packet serving as a target to be processed in said first relay node, said process-target packet including process-identifying information indicating a content of a process to be executed, and process-target data serving as a target of the process;
when the received packet is said process-target packet in the relay node, executing, by said first relay node, a process corresponding to said process-identifying information included in the packet on said process-target data included in the packet, in accordance with said process rules;
determining, by said first relay node, a second relay node that is a destination to which a result obtained by processing said process-target data is transferred;
transmitting, by said first relay node, the result obtained by processing said process-target data to said second relay node; and
when the received packet is not said process-target packet in the relay node, transferring, by said first relay node, the received packet to another relay node in accordance with route control information.

10. The information processing method according to claim 9, further comprising generating, by said first relay node, a packet including the result obtained by processing said process-target data, as said process-target data.

11. The information processing method according to claim 10, further comprising, upon receiving said process-target packet at said second relay node from said first relay node, executing, by said second relay node, a process corresponding to said process-identifying information included in the packet on said process-target data included in the packet.

12. The information processing method according to claim 9 or 10, wherein
said process rules include a definition for repeating a same process a prescribed number of times, and
when a packet including designation for repeating a same process a prescribed number of times as said process-identifying information is received, the step of executing includes repeating the process until said process-target packet is received by the designated number of times. S18, S20).
